(19) United States
(12) Patent Application Publication
(10) Pub. No.: US 2003/0084634 A1
(43) Pub. Date: May 8, 2003

(54) Transition molding

(76) Inventor: Oliver Stanchfield, Raleigh, NC (US)

Correspondence Address: STEVENS, DAVIS,, MILLER & MOSHER, L.L.P., Suite 850, 1615 L Street, N.W., Washington, DC, 20036, US

(21) Appl. No.: 09/986,414

(22) Filed: Nov. 8, 2001

(51) Int. Cl. B23P 11/02

(52) U.S. Cl. 52/464; 52/461

(57) ABSTRACT

The invention is a joint cover assembly for covering a gap adjacent an edge of a panel that covers a sub-surface, and a method of covering such a gap. The assembly includes a molding having a flange, a first bar, and a second bar. The flange is positioned along a longitudinal axis, and the first bar extends generally orthogonally from the flange. The second bar extends generally orthogonally from the flange. A tab depends generally orthogonally from the first panel engaging surface. At least one of the tab and the flange engage the edge in order to tightly fit within the gap. The method includes the steps of placing the flange in the gap, pressing the respective panel engaging surfaces into contact with respective panels, and configuring at least one of the tab and the flange to cooperate to retain the molding in the gap when the assembly is in an installed condition.

### FIELD OF INVENTION

The invention is a joint cover assembly that includes a molding, similar to a T-Molding, for covering a gap that may be formed adjacent a panel in a generally planar surface, such as a floor or wall.

### BACKGROUND OF THE INVENTION

Wood or laminate flooring has become increasingly popular. As such, many different types of this flooring have been developed. Generally, this type of flooring is assembled by providing a plurality of similar panels. The differing types of panels that have developed, of course, may have differing depths and thicknesses.

It is necessary to provide a smooth transition or edge to the floor, such as at the corner of a wall. The edges near a wall are commonly known as edge or corner moldings.

Additionally, one may desire to floor adjacent areas with different types of material. One instance where this may be desired, for example is in the differing rooms of a home. Specifically, one may desire to have one type of flooring in a kitchen, and a different appearance in an adjacent living room, and an entirely different look in an adjacent bath. In order to accomplish this, became necessary to develop a type of molding accomplish this, became necessary to develop a type of molding or seal that could be used as a transition from one type of flooring to another.

A problem is encountered, however, when one desires to use flooring materials that are dissimilar in shape or texture. For example, when one desires to have a hard floor adjacent a carpet, problems are encountered with the edge moldings of the prior art. Additionally, the prior art moldings encountered difficulty in covering the gap that may be formed between flooring of differing height or thickness.

Moreover, for purposes of reducing cost, it is important to be able to have a molding that is versatile; meaning it could be used to cover a gap between relatively coplanar surfaces, as well as surfaces of differing thicknesses.

### SUMMARY OF THE INVENTION

The invention is a joint cover assembly for covering a gap adjacent an edge of a panel, such as that covers a sub-surface. The assembly includes a body having a flange positioned along a longitudinal axis, and a first bar extending generally orthogonally from the flange, and bearing a generally planar first panel engaging surface. The assembly also has a second bar extending generally orthogonally to the flange, and bearing a second generally planar panel engaging surface. A tab is on the first panel engaging surface and displaced from the flange, depending orthogonally from the first panel engaging surface.

The assembly may also include a rail positioned adjacent the edge, wherein the flange is configured to be slidingly retained within the rail. In a preferred embodiment, the rail is coupled directly to the subsurface that is covered by the panel.

The outward-facing surface of the assembly may be formed as a single, unitary, monolithic surface that covers both bars. This outward-facing surface may be treated, for example, covered with a laminate or a paper, such as a decor, impregnated with a resin, in order to increase its aesthetic value, or blend, match, or contrast with the panels.

A shim may be placed between the flange and the subfloor. In a preferred embodiment, the shim may be positioned on the underside of the rail; however, if a rail is not used, a shim may be positioned between the flange and the subfloor. Additionally, the shim may be adhered to either the flange or subfloor using an adhesive or any known fastener (such as a nail or screw).

The assembly may also include a reducer positioned between the first arm and the subfloor. The reducer has a top that engages the first panel engaging surface, and a bottom that engages the subfloor, as well as a channel formed in the top and configured to engage and receive the tab. The reducer is configured to keep the first arm, second arm, and an outward facing surface of the panel relatively coplanar when an edge of a material thinner than the panel is positioned beneath the first arm. The material may comprise any of a carpet, laminate flooring, ceramic or wood tile, linoleum, turf, paper, natural wood or veneer, vinyl, wood, ceramic or composite finish, or any type of covering. The reducer facilitates one to use coverings having varying thicknesses are desired to cover a subfloor. The reducer helps the molding not only cover the gap, but provide a smoother transition from one surface to another.

Alternatively, the tab may be positioned and configured to slidingly engage the edge of a panel. A lip may be positioned and configured on the tab in order to slidingly engage a protuberance adjacent an upper edge of the rail in order to retain the assembly in its installed position.

The tab may be frustum-shaped with a large base distal the first panel engaging surface. Additionally, the tab may be lobe shaped, having a bulbous end distal the first panel engaging surface. Of course, any suitable shape would suffice, provided the tab is sufficiently sturdy, and may facilitate any of the functions set forth in the preceding paragraphs.

The assembly may be used to cover gaps between tongue-and-groove type panels, such as the so-called glue-free laminate floors. In addition to the uses mentioned above, the tab may also engage the edge of one of the panels, or may actually fit within a grooved edge. In order to better accommodate this type of gap, a second tab may be positioned to depend from the second panel engaging surface.

The assembly may be used in other non-coplanar areas, such as the edge between a wall and a floor, or even on stairs. The detachment of the first bar may increase the suitability for this purpose.

An adhesive, such as a glue, a microballoon adhesive, contact adhesive, or chemical adhesive, may be positioned on the tab, the flange, the first panel engaging surface, and/or the second panel engaging surface. Of course, such an adhesive is not necessary, but may enhance or supplement the snap-type fit of the assembly into the gap. Additionally, the adhesive may assist in creating a more air-tight or moisture-tight joint.

The inventive assembly may be used for positioning between adjacent tongue-and-groove panels; in this regard, the assembly functions as a transition molding, which provides a cover for edges of dissimilar surfaces. For example, when installing floors into a home, the assembly could be used to provide an edge between a hallway and a bedroom, between a kitchen and living or bathroom, or any areas where distinct flooring is desired. Additionally, the assembly may be incorporated into differing types of flooring, such as wood, tile, linoleum, carpet, or turf.

The invention also is drawn to an inventive method for covering a gap between adjacent panels of a generally planar surface. The method includes myriad steps, including, inter alia, the steps of placing the flange in the gap, pressing the respective panel engaging surfaces into contact with respective panels, and configuring at least one of the tab and the flange to cooperate to retain the molding in the gap when the assembly is in an installed condition.

These and other objects, uses, and functions of the above-referenced invention will become apparent from the following written description, taken together with the accompanying drawings and appended claims.

### BRIEF DESCRIPTION OF THE DRAWINGS

FIG. 1 is an exploded view of a preferred embodiment of the joint cover assembly, according to the principles of the invention

FIG. 2 is a perspective view of one embodiment of the joint cover assembly, according to the principles of the invention, shown in an installed condition.

FIGS. 3 and 3A are a comparative perspective views of respective preferred embodiments of the retainer, according to the principles of the invention.

FIG. 4 shows the underside of a molding portion of a preferred embodiment of the joint cover assembly.

FIGS. 5 and 5A are a comparative perspective views of respective preferred embodiments of the retainer, according to the principles of the invention.

FIGS. 6-16 show comparative cross-sectional views of various embodiments of the molding portion of the joint cover assembly, according to the principles of the invention.

### DETAILED DESCRIPTION OF THE PREFERRED EMBODIMENTS

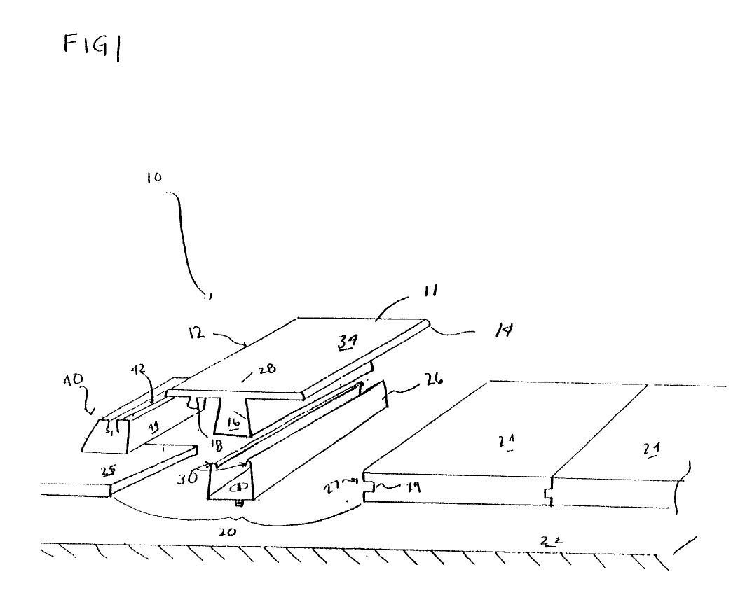

FIG. 1 shows an exploded view of the various parts of the inventive joint cover assembly 10. The joint cover assembly includes a T-like molding 11, having a flange 16 formed so that it can fit between the gap 20 formed adjacent an edge 27 of a panel 24.

As shown in FIG. 1, the panels 24 are the tongue-and-groove type, having a groove 27 positioned near the gap 20; however, the tongue and groove type of panel is not necessary.

A first bar 12 extends generally orthogonal to the flange from adjacent a first end of the flange 16, and a second bar 12 extends generally orthogonally from adjacent the first end of the flange 16. As shown, the flange 16, first bar 12, and second bar 14 from a general T-shape. This T-shape, while a preferred embodiment, is not mandatory, of course.

The joint assembly 10 is best used for covering a gap 20 formed between adjacent edges of adjacent panels, such as coverings for a subfloor 22. the various coverings for the subfloor 22 may be panels 24, as shown, but may also be tile, linoleum, turf, or carpet, wood, vinyl, ceramic or composite finish, or other materials as mentioned herein. In order to increase aesthetics, the upper surface 34 of the molding 11 may be selected to match or blend with the decor of the panels 24.

The molding 11 may be formed of any suitable, sturdy material, such as wood, polymer, wood, or even a wood/polymer composite. Due to the growing popularity of wood and laminate flooring and wood wall paneling, however, many prefer a natural or simulated wood-grain appearance on the outward facing surface 34. Thus, in the event natural wood or wood veneer is not selected as the material, the appearance of wood may be simulated by coating the surface 34 with a laminate having a decor sheet that simulates wood. Alternatively, the decor can simulate stone, brick, inlays, or even fantasy patterns.

A rail 26 is coupled to the subfloor 22 within the gap 20. as shown, the rail may be coupled to the subfloor 22 by means of fasteners, such as screws (as shown); however, any known method of coupling would suffice. The rail 26 and the flange 16 are preferably cooperatively formed so that the flange 16 is slidingly retained within the rail 26 when the rail is installed.

The rail may be formed of a sturdy, yet pliable material that will outwardly deform as the flange is inserted, but will retain the flange 16 therein. Such materials include, but are not limited to, plastic, wood/polymer composites, wood, polymers, etc.

A tab 18 depends from the first bar. As shown in FIG. 1, the tab 18 depends downward from the first bar, and runs generally parallel to the flange 16. As shown in FIG. 1, the tab may bear the shape of a frustum with its larger base distal the first bar 12; however, other suitable shapes are possible, as will be discussed hereinafter.

As shown in FIG. 1, the assembly further includes a retainer 40 having a channel 42 that is formed to receive the tab 18. When the molding 11 is required to cover a gap 20 between panels 24, 25 of differing heights, as is shown in FIG. 1, the retainer 40 is positioned between the first arm 12 and the subfloor 22.

Even though the assembly 10 may function without any type of glue or adhesive, an alternate embodiment includes the placement of adhesive 31 on the molding 11. The adhesive may be placed on molding 11 at the factory (for example, pre-glued); alternatively, the glue may be applied while the panels are being assembled. As shown in FIG. 1, the adhesive is a strip-type adhesive, but any type of adhesive, such as glue, chemical or chemically-activated adhesives, contact cements, microballoon adhesives, etc. may be used. Additionally, while the embodiment in FIG. 1 shows the adhesive strips 31 attached to respective panel engaging surface 36, the adhesive may also be attached to the tab 18, flange 16, the ridges 32, or any suitable place. Preferably, adhesive should only be applied to one of the panel engaging surfaces 36, 38, in order to allow accommodate some slight relative movement that may occur during changes of temperature, for example. Allowing a slight amount of movement may also eliminate unneeded material stresses as well, thereby reducing warping or deterioration of the material surface.

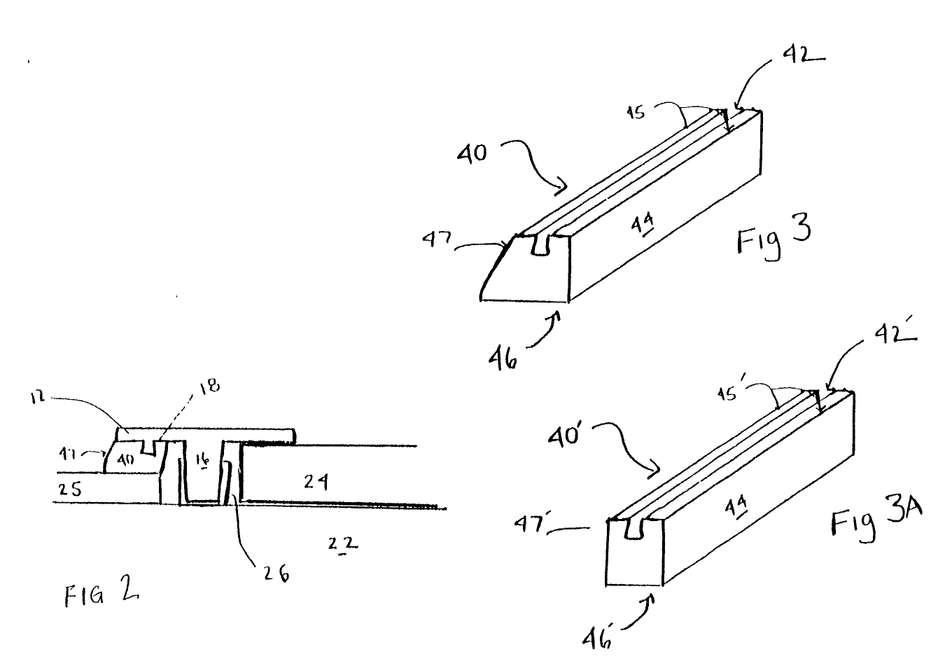

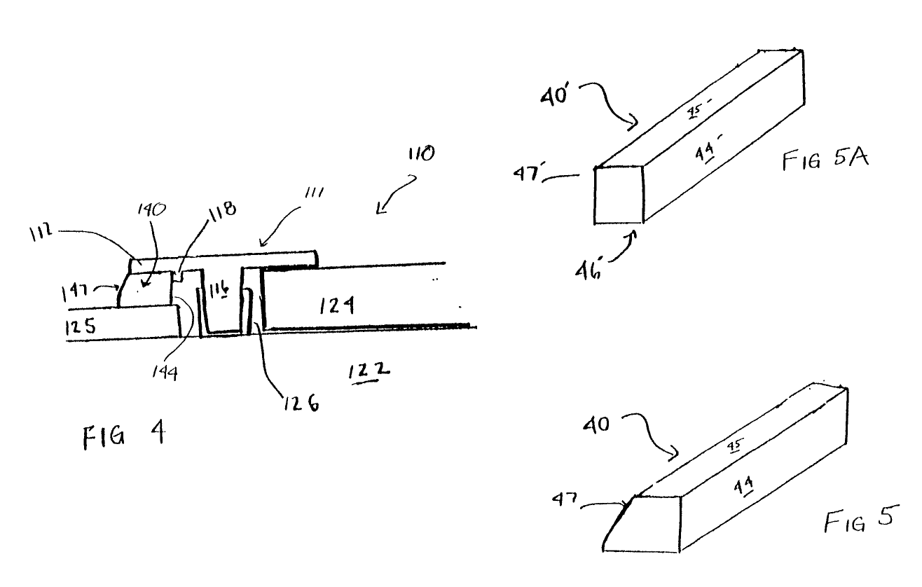

FIG. 2 shows a preferred embodiment of the assembly 10 in an installed condition, wherein the panels 24, 25 are of differing thicknesses. Of course, the panel 24 may be of any type of covering, such as carpet, turf, tile, linoleum or the like. As shown in FIG. 3, the retainer 40 includes a bottom 46, and a top 45 having a channel 42, and an inner surface 44.

Referring now again to FIG. 2, note that the top 45 of the retainer firmly engages the panel engaging surface 36 of the first arm 12, and the bottom 46 engages panel 25. Note that the tab 18 is firmly held within the channel 42 of the retainer 40. Viewing FIGS. 2 and 3 together, note that the inner surface 44 of the retainer 44 does not engage the flange, as shown. Generally, a small amount of clearance is preferred between the rail 26 or flange 16 and the inner surface 44; however, the inner surface 44 may optionally be configured to engage one of the rail 26 or flange 16.

The retainer 40 may be made of a composite, pliable material that has some “give” to it. For example, the tab 18 may be formed to be slightly larger than the opening of the channel 42, thereby forcing the channel 42 to outwardly deform in order to accommodate the tab 18, and therefore snap-fit together.

As shown in FIG. 3, the outer surface 47 of the retainer 40 is generally treated to match or blend with the outer surface 34 of the molding, in order to improve aesthetics. Therefore, the outer surface 47 may be treated in the same way as the outward facing surface 47, as discussed herein. Alternatively, the outer surface 47 can be treated to contrast with the outer surface 34.

FIG. 3a shows an alternate embodiment of the retainer 40′. Note that corresponding parts that perform analogous functions of this alternate retainer 40′ are afforded similar reference numbers, for clarity. The outer surface 47′ of this embodiment is configured generally orthogonal to the upper surface 44′ and the lower surface 46′ of the retainer 40′. This alternate configuration of the outer surface 47′ not only provides a different appearance, it also has been shown to be preferred when softer surfaces, such as carpet or turf, are positioned beneath the lower surface 46′ of the retainer 40′.

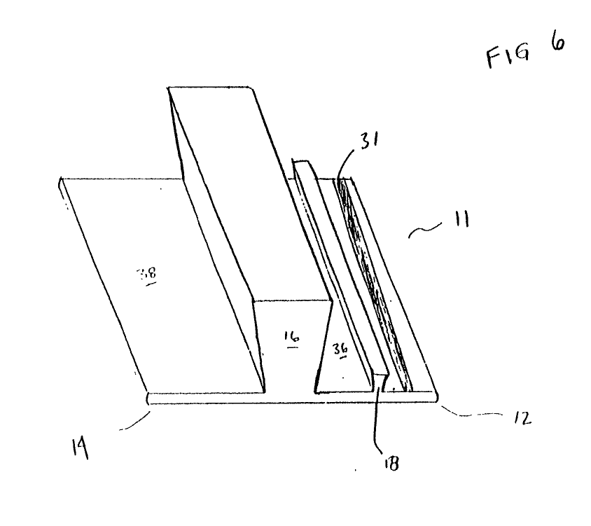

FIG. 4 shows yet another alternate embodiment of the retainer 140. In the illustration of this alternate embodiment, the analogous parts have been assigned referenced numbers that are increased by one-hundred, for clarity purposes. For example, the retainer 140 (as in FIG. 4) is analogous to the retainer 40 and 40′ of FIGS. 1-4.

As shown in FIG. 4, the retainer may be positioned between a first arm 112 of the molding 111 and the panel 125. In this embodiment of the assembly 110, the tab 118 engages the inner surface 144 of the retainer 140.

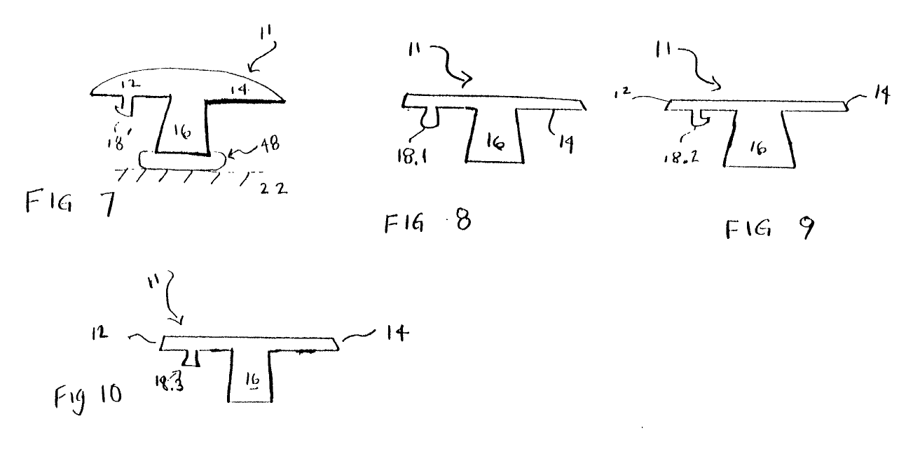

FIG. 5 shows an embodiment of a retainer 140 that may be used in the assembly shown in FIG. 4. Specifically, note that the retainer 140 in FIG. 5 has a solid, uninterrupted upper surface 145—there is no need for a channel because the tab (118, as in FIG. 4) will engage the inner surface 44 instead of the top surface 145.

FIG. 5A shows other embodiment of a retainer 140′ that can be incorporated into the assembly shown in FIG. 4. Similar to the embodiment of FIG. 3A, the embodiment shown in FIG. 5A has a front surface 1461 that will be generally orthogonal to the floor 122 (as shown in FIG. 4) when the retainer 140′ is installed. This perpendicular configuration of the front surface 147′ not only provides a different appearance, it has also been found to be preferred with softer surfaces, such as carpet or turf.

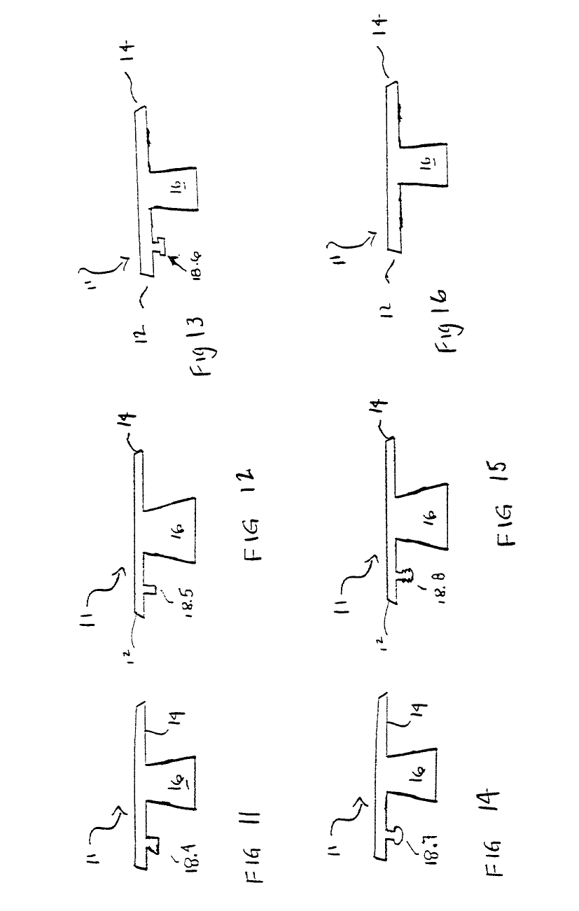

FIG. 6 shows an underside view of the molding 11. The molding 11 has a first panel engaging face 36 on the first bar 12, and a second panel engaging face 38 on the second bar 14. Preferably, panel engaging surface 36 bears an adhesive 31 positioned to adhere to a surface of a panel or retainer (not shown in FIG. 6, but viewable in FIG. 1, for example).

FIGS. 7-15 show various cross-sectional views of the molding 11. These figures show comparative configurations for the arms 12, 14, the tab 18, and the upper surface.

In FIG. 7, the tab 18 is selected to be an outward-facing hook having a pointed end facing away from the flange. This particular selection for a tab may be used to engage an edge or groove of an adjacent panel. Additionally, note that FIG. 5 shows a shim 48 positioned between the flange 16 and the subfloor 22. The shim 48 is generally selected of a pliable and flexible, yet durable material. The shim 48 may also be used in combination with the rail 26 as well.

FIGS. 8-15 show comparative cross-sections of other embodiments of the molding 11. The configurations of the moldings are very similar, except for the shape of the tab. The differing tabs have been assigned decimal numbers beginning with 18, for clarity purposes. The tab 18.1 of the embodiment shown in FIG. 8 is a depending bulbous shape, having a large end distal the first panel engaging surface 36 of the first bar 12.

FIG. 9 shows a cross-section of another embodiment of the molding 11. The tab 18.2 of this embodiment is shown to be a hook-shape with a point facing the flange 16.

FIG. 10 shows the cross-section of yet another embodiment of the molding 11. In this embodiment, the tab 18.3 is shown to be a frustum-shape, similar to the shape of the tab 18 shown in FIG. 2.

The purpose of the various-shaped tabs (18-18.8) is multi-fold. Primarily, the tab 18 serves to engage the channel 42 of the retainer 40, which is used when covering of differing thickness is used. Alternatively, the respective tab (18-18.8) may engage an edge of a panel, carpet, turf, or other type of floor covering. As shown herein, the respective tab (18-18.8) may even be configured to engage a retainer.

FIG. 16 shows an embodiment of the molding 11 having arms 12, 14 extending opposed to a central flange 16; note that this embodiment does not include a depending tab. Preferably, this embodiment of the molding 11 includes an adhesive on the underside of one of the arms 12, 14.

Having described the invention in detail, the examples herein discussed are set forth for illustrative purposes only, and not for limitation. It will be support to those skilled in the art that the disclosure can be modified without departing from the scope and spirit of the invention.

I claim:

1. A joint cover assembly for covering a gap adjacent an edge of a panel that covers a sub-surface, the assembly comprising:
a molding, including
a flange positioned along a longitudinal axis;
a first bar extending generally orthogonally from the flange, and having generally planar first panel engaging surface;
a second bar extending generally orthogonally from the flange, and having second panel engaging surface;
a tab positioned on the first panel engaging surface and displaced from the flange, the tab depending generally orthogonally from the first panel engaging surface; and,
wherein at least the tab and the flange cooperate to retain the molding in the gap when the assembly is in an installed condition.

2. A joint cover assembly as in claim 1, further comprising
a rail positioned adjacent the edge, wherein
the flange is configured to be slidingly retained within the rail.

3. The joint cover as in claim 1, further comprising an outward-facing surface configured to face outwardly when the assembly is in an installed condition, and, wherein
the outward facing surface is a single, unitary, monolithic surface positioned to cover each of the first and second bars, the outward facing surface facing generally opposite each of the first and second floor engaging surfaces.

4. The joint cover assembly as in claim 1, further comprising
a reducer positioned between the first arm and the subfloor, the reducer having a top that engages the first panel engaging surface, a bottom that engages the subfloor, and a channel formed in the top and configured to engage and receive the tab; wherein,
the reducer is configured to keep the first arm, second arm, and an outward facing surface of the panel relatively coplanar when an edge of a material thinner than the panel is positioned beneath the first arm.

5. The joint cover assembly as in claim 4, further comprising an adhesive positioned on at least one of the channel, the top of the reducer, or the bottom of the reducer.

6. The joint cover assembly as in claim 1, wherein the tab is frustum-shaped with a large base distal the first panel engaging surface.

7. The joint cover assembly as in claim 1, wherein the tab is lobe shaped, having a bulbous end distal the first panel engaging surface.

8. The joint cover assembly as in claim 1, further comprising:
an adhesive comprising at least one of
a glue, a microballoon adhesive, contact adhesive, or chemical adhesive,
the adhesive positioned on at least one of
the tab, the flange, the first panel engaging surface, or the second panel engaging surface.

9. The joint cover assembly as in claim 1, wherein
the gap is formed between adjacent tongue-and-groove panels, and
the tab is formed to engage a groove of an adjacent panel when the assembly is in an installed condition.

10. The joint cover assembly as in claim 1, further comprising a second tab depending from the second panel engaging surface.

11. A joint cover assembly for covering a gap adjacent an edge of a panel that forms a cover for a sub-surface, the assembly comprising:
a flange configured to be positioned within the gap;
a first member generally orthogonal to the flange, and having generally planar first panel engaging surface;
a second member extending generally orthogonal to the flange, and having second panel engaging surface;
a tab running generally parallel to the flange and positioned on the first member, the tab depending from the first panel engaging surface;
a rail coupled to the subsurface and positioned within the gap and adjacent the edge;
wherein the flange slidingly engages the rail in order to retain the molding over the gap when the assembly is in an installed condition.

12. A joint cover assembly as in claim 11, further comprising
a reducer positioned between the first member and the subfloor, the reducer having a top that engages the first panel engaging surface, a channel cooperatively formed in the top to engage and receive the tab, and a bottom that engages the subfloor,
wherein, the reducer is configured to keep the first member, second member, and an outward facing surface of the panel relatively coplanar when an edge of a material thinner than the panel is positioned beneath the first member.

13. The joint cover assembly as in claim 12, wherein the tab slidingly engages into the channel when the reducer is attached to the molding.

14. The joint cover assembly as in claim 12, wherein the tab is snap-fit into the channel when the reducer is attached to the molding.

15. The joint cover assembly as in claim 12, further comprising an adhesive including at least one of a glue, microballoon adhesive, contact adhesive, epoxy, or strip adhesive, positioned on at least one of the top, bottom, or channel of the reducer.

16. The joint cover assembly as in claim 11, further comprising a shim positioned between the flange and the subfloor.

17. The joint cover assembly as in claim 11, wherein the tab is one of
frustum-shaped with a large base distal the first panel engaging surface; or,
lobe shaped, having a bulbous end distal the first panel engaging surface; or,
has a general hook shape, and a lip is formed at a point of the hook.

18. The joint cover assembly as in claim 11, further comprising:
an adhesive composed of at least one of
a glue, a microballoon adhesive, contact adhesive, or chemical adhesive,
the adhesive positioned on at least one of
the tab, the flange, the first panel engaging surface, or the second panel engaging surface.

19. The joint cover assembly as in claim 11, wherein material is one of carpet, tile, panel, or linoleum.

20. The joint cover assembly as in claim 11, further comprising a second tab depending from the second panel engaging surface.

21. A method of covering a joint between two generally coplanar surfaces, the method comprising the steps of
providing a molding including
a flange positioned along a longitudinal axis;
a first bar extending generally orthogonally from the flange, and having generally planar first panel engaging surface;
a second bar extending generally orthogonally from the flange, and having second panel engaging surface;
positioning a tab on the first panel engaging surface and displaced from the flange, the tab depending generally orthogonally from the first panel engaging surface; and,
placing the flange in the gap;
pressing the respective panel engaging surfaces into contact with respective panels; and
configuring at least one of the tab and the flange to cooperate to retain the molding in the gap when the assembly is in an installed condition.

22. The method as in claim 21, further comprising the steps of providing adhesive to the molding.

23. The method as in claim 21, further comprising the steps of
coupling a rail to the subsurface;
positioning the rail within the gap and adjacent the edge; and,
engaging the flange within the rail during the pressing step.

24. The method as in claim 21, further comprising the step of
positioning a reducer between the first bar and the subfloor, the reducer having a top that engages the first panel engaging surface, a channel cooperatively formed in the top to engage and receive the tab, and a bottom that engages the subfloor,
wherein, the reducer is configured to keep the first bar, second bar, and an outward facing surface of the panel relatively coplanar when an edge of a material thinner than the panel is positioned beneath the first bar.

25. The method as in claim 21, further comprising the step of applying adhesive on at least one of the channel, the top of the reducer, or the bottom of the reducer.

26. The method as in claim 21, wherein the tab is frustum-shaped with a large base distal the first panel engaging surface.

27. The method in claim 21, wherein the tab is lobe shaped, having a bulbous end distal the first panel engaging surface.

28. The method as in claim 22, further comprising the step of
positioning the adhesive on at least one of
the tab, the flange, the first panel engaging surface, or the second panel engaging surface, wherein,
the adhesive is at least one of a glue, a microballoon adhesive, contact adhesive, or chemical adhesive.

29. The method as in claim 21, wherein
the gap is formed between adjacent tongue-and-groove panels, and
the tab is formed to engage a groove of an adjacent panel when the assembly is in an installed condition.

30. The method as in claim 21, further comprising the step of
positioning a second tab depending from the second panel engaging surface.
